(19) United States
(12) Patent Application Publication
(10) Pub. No.: US 2007/0246891 A1
(43) Pub. Date: Oct. 25, 2007

(54) SHAFT-SEALING DEVICE HAVING AN INNER SEALING-RING POSITIONING ASSEMBLY FOR A ROTARY MACHINE

(76) Inventor: Cheng-Shiou Huang, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/380,123

(22) Filed: Apr. 25, 2006

(51) Int. Cl. F16J 15/34

(52) U.S. Cl. 277/361

(57) ABSTRACT

A shaft-supporting mechanism of a shaft-sealing device includes a sealing-ring positioning assembly, a pair of pushing members, a sleeve body, a first rotatable sealing ring and a second rotatable sealing ring. The sealing-ring positioning assembly includes a plurality of spring members and a plurality of engaging legs longitudinally extended in opposite directions to define limiting spaces where the pushing members are correspondingly restricted. The pushing members are located at opposite sides of the sealing-ring positioning assembly between which the spring members are arranged. In assembling, the sealing-ring positioning assembly, the pushing members, the first rotatable sealing ring and the second rotatable sealing ring are assembled on the sleeve body. Spring forces of the spring members can actuate the pushing members to push the first rotatable sealing ring and the second rotatable sealing ring in the opposite directions.

### BACKGROUND OF THE INVENTION

1. Field of the Invention

The present invention relates to a shaft-sealing device for a rotary machine. Particularly, the present invention relates to the shaft-sealing device having an inner sealing-ring positioning assembly. More particularly, the present invention relates to the inner sealing-ring positioning assembly used to position a pair of rotatable sealing rings abutting against fixed sealing rings.

2. Description of the Related Art

Referring initially to FIG. 1, a conventional rotary machine such as a pump system has a rotary shaft 9 which may be used to stir liquids contained in a liquid tank. In rotating operation, the rotary machine functions as a stirring apparatus of the liquid tank for example. The rotary machine generally includes a shaft sealing structure for sealing liquids such as cooling fluid which circulates therein.

Typically, the shaft sealing structure includes a shaft-mounting seat 7 and a shaft-supporting mechanism 8. The shaft-mounting seat 7 permits extension of the rotary shaft 9 and mounts the rotary shaft 9 on equipments such as liquid tanks. Furthermore, the shaft-supporting mechanism 8 is securely mounted on the rotary shaft 9 and rotated therewith such that the shaft-supporting mechanism 8 rotatably supports the rotary shaft 9 in a rotary-shaft bore 70 of the shaft-mounting seat 7. The rotary-shaft bore 70 is longitudinally extended through the entire shaft-mounting seat 7 as well as the entire shaft-sealing device. Screw-connected with the shaft-mounting seat 7 is a shaft-seat cap 7′. The shaft-mounting seat 7 further includes a coolant inlet 71, a coolant outlet 72 and a pair of fixed sealing rings 73. In rotating operation, a coolant may be dispensed from the coolant inlet 71 to the coolant outlet 72 and thus circulates in the shaft-mounting seat 7. The fixed sealing rings 73 are disposed in interiors of the shaft-mounting seat 7 and the shaft-seat cap 7′, and engage against corresponding sealing parts. In this way, one of the fixed sealing rings 73 is mounted in the shaft-mounting seat 7 while the other is mounted in the shaft-seat cap 7′.

The shaft-supporting mechanism 8 includes a sealing-ring positioning assembly 81, a pair of pushing members 82, a pair of resilient gaskets (i.e. O-ring) 83, a pair of rotatable sealing rings 84 and a sleeve body 85. The sealing-ring positioning assembly 81, the pushing members 82, the resilient gaskets 83 and the rotatable sealing rings 84 are mounted and assembled on an outer circumference of the sleeve body 85 in order. There are a series of spring members 810 provided on each opposite side of the sealing-ring positioning assembly 81 so that bias forces of the spring members 810 are exerted on the pushing members 82 in opposite directions. Each first end side surface of the pushing members 82 is in contact with the corresponding spring members 810 while each second end side surface of the pushing members 82 is in contact with the corresponding rotatable sealing rings 84. Disposed between the pushing members 82 and the rotatable sealing rings 84 are the resilient gaskets 83 for providing sealing effects therebetween. Each of the rotatable sealing rings 84 is closely contacted with each of the corresponding fixed sealing rings 73. Furthermore, the sleeve body 85 is mounted on the rotary shaft 9 and rotated therewith.

When the rotary shaft 9 rotates, the fixed sealing rings 73 of the shaft-mounting seat 7 elastically engage against the rotatable sealing rings 84 of the shaft-supporting mechanism 8. In long-term use, there are abrasions occurring between the fixed sealing rings 73 of the shaft-mounting seat 7 and the rotatable sealing rings 84 of the shaft-supporting mechanism 8. The bias forces of the spring members 810 ensure no clearance existing between the fixed sealing rings 73 and the rotatable sealing rings 84 by the pushing members 82 successively pushing the corresponding rotatable sealing rings 84. Consequently, the bias forces of the spring members 810 can reduce the possibilities of liquid leakage in the interior of the shaft-sealing device.

The conventional shaft sealing structure of the rotary machine has several drawbacks in manufacture. In the installing process, the spring members 810 must be disposed between each side of the sealing-ring positioning assembly 81 and the corresponding rotatable sealing rings 84 without any positioning member prior to completely fixing the shaft-supporting mechanism 8 on the rotary shaft 9. The primary problem with such a structure is the difficulty in assembling due to the fact that the spring members 810 may be fallen off from the sealing-ring positioning assembly 81 or mis-aligned therein. Disadvantageously, this may result in a lower efficiency of the installing process.

Another problem naturally occurring during use of such a shaft sealing structure is due to the fact that liquids contained in the liquid tank may permeate through a clearance existing between the pushing member 82 and the rotatable sealing rings 84. In this circumstance, the liquid pressure can press the resilient gasket 83 and the pushing member 82 to be moved backward to the sealing-ring positioning assembly 81, and thus compress the spring members 810 to be retracted. Consequently, the rotatable sealing rings 84 cannot exactly abut against the corresponding fixed sealing rings 73. Disadvantageously, there is an increase of the possibility of leakage in such a shaft sealing structure. Hence, there is a need for improving the conventional shaft sealing structure.

As is described in greater detail below, the present invention intends to provide a shaft-sealing device having a sealing-ring positioning assembly, wherein the sealing-ring positioning assembly includes a plurality of engaging legs longitudinally extended in opposite directions to define limiting spaces for limiting pushing members. The engaging legs further extend into engaging notches of rotatable sealing rings to enhance an assembled relationship therebetween. Furthermore, a shaft-supporting mechanism has a positioning flange of a sleeve body to position a resilient gasket for a perfect sealing effect in such a way as to mitigate and overcome the above problem.

### SUMMARY OF THE INVENTION

The primary objective of this invention is to provide a shaft-sealing device having a sealing-ring positioning assembly which includes a plurality of engaging legs longitudinally extended in opposite directions to define limiting spaces where pushing members are received to restrict spring members in the sealing-ring positioning assembly. Accordingly, the sealing-ring positioning assembly can be pre-assembled for easy installation.

The secondary objective of this invention is to provide the shaft-sealing device having a shaft-supporting mechanism which provides a positioning flange of a sleeve body for positioning a resilient gasket thereon. Accordingly, the positioning flange of the sleeve body can enhance the sealing effect of the shaft-supporting mechanism.

Another objective of this invention is to provide the shaft-sealing device having a shaft-mounting seat in which to provide with a liquid guiding member which is in alignment with a coolant inlet and a coolant outlet. Accordingly, the liquid guiding member can guide a flow of the coolant in an interior of the shaft-mounting seat along a rotational direction of a rotary shaft.

The shaft-sealing device in accordance with an aspect of the present invention includes a shaft-mounting seat and a shaft-supporting mechanism. The shaft-mounting seat is mounted on a liquid tank by means of screw connections. The shaft-supporting mechanism is provided in an interior of the shaft-sealing device, and is mounted on a rotary shaft by means of screw connections for a synchronous rotation. The shaft-supporting mechanism includes a sealing-ring positioning assembly, a pair of pushing members, a sleeve body, a first rotatable sealing ring and a second rotatable sealing ring. The sealing-ring positioning assembly includes a plurality of spring members and a plurality of engaging legs longitudinally extended in opposite directions to define limiting spaces where the pushing members are correspondingly restricted. The pushing members are located at opposite sides of the sealing-ring positioning assembly between which the spring members are arranged. In assembling, the sealing-ring positioning assembly, the pushing members, the first rotatable sealing ring and the second rotatable sealing ring are assembled on the sleeve body. Spring forces of the spring members can actuate the pushing members to push the first rotatable sealing ring and the second rotatable sealing ring in the opposite directions.

In a separate aspect of the present invention, an engaging block is formed on an inner surface of the engaging leg of the sealing-ring positioning assembly.

In a further separate aspect of the present invention, the pushing member has an engaging cutaway portion to engage with the engaging leg of sealing-ring positioning assembly.

In a yet further separate aspect of the present invention, the sleeve body is provided with a positioning flange on its outer circumference to position a resilient gasket.

In a yet further separate aspect of the present invention, the shaft-sealing device further includes a liquid guiding member.

In a yet further separate aspect of the present invention, the liquid guiding member includes flow-guiding portions aligned with a coolant inlet and a coolant outlet of the shaft-mounting seat.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a cross-sectional view of a conventional shaft-sealing device in accordance with the prior art;

FIG. 2 is an exploded perspective view of a shaft-sealing device having an inner sealing-ring positioning assembly in accordance with a preferred embodiment of the present invention;

FIG. 3 is an assembled, cross-sectional view of the shaft-sealing device having the inner sealing-ring positioning assembly in accordance with the preferred embodiment of the present invention; and

FIG. 4 is a cross-sectional view, taken along line 4-4 in FIG. 3, of a shaft-mounting seat of the shaft-sealing device in accordance with the preferred embodiment of the present invention.

### DETAILED DESCRIPTION OF THE INVENTION

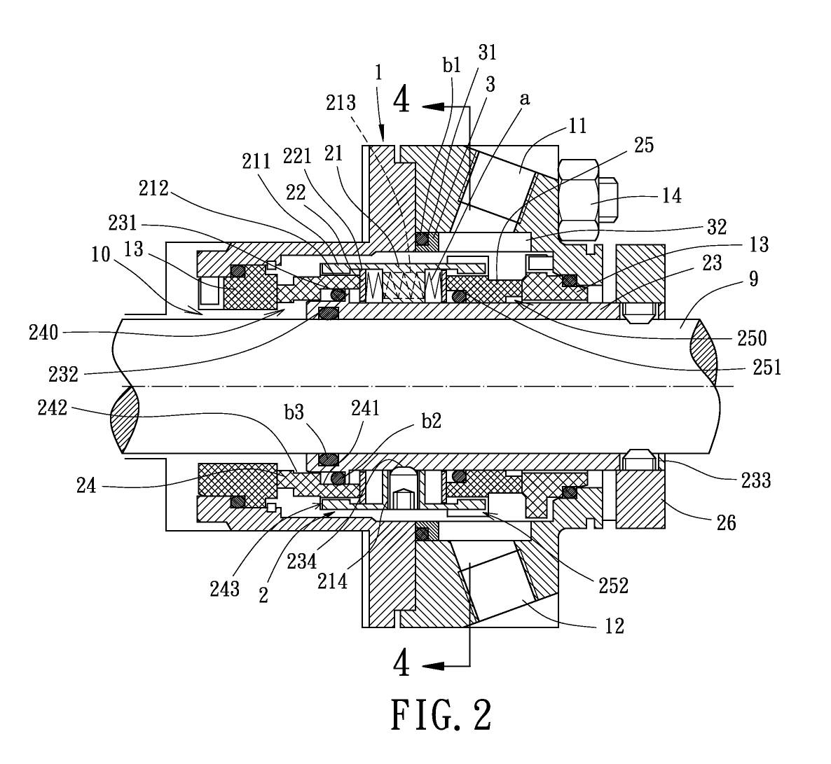

Referring now to FIGS. 2 through 4, views of a shaft-sealing device having an inner sealing-ring positioning assembly in accordance with the preferred embodiment of the present invention includes a shaft-mounting seat designated numeral 1, a shaft-supporting mechanism designated numeral 2 and a liquid guiding member designated numeral 3. In the illustrated embodiment, the shaft-sealing device is installed on a rotary machine which may mechanically connected to a liquid tank or the like.

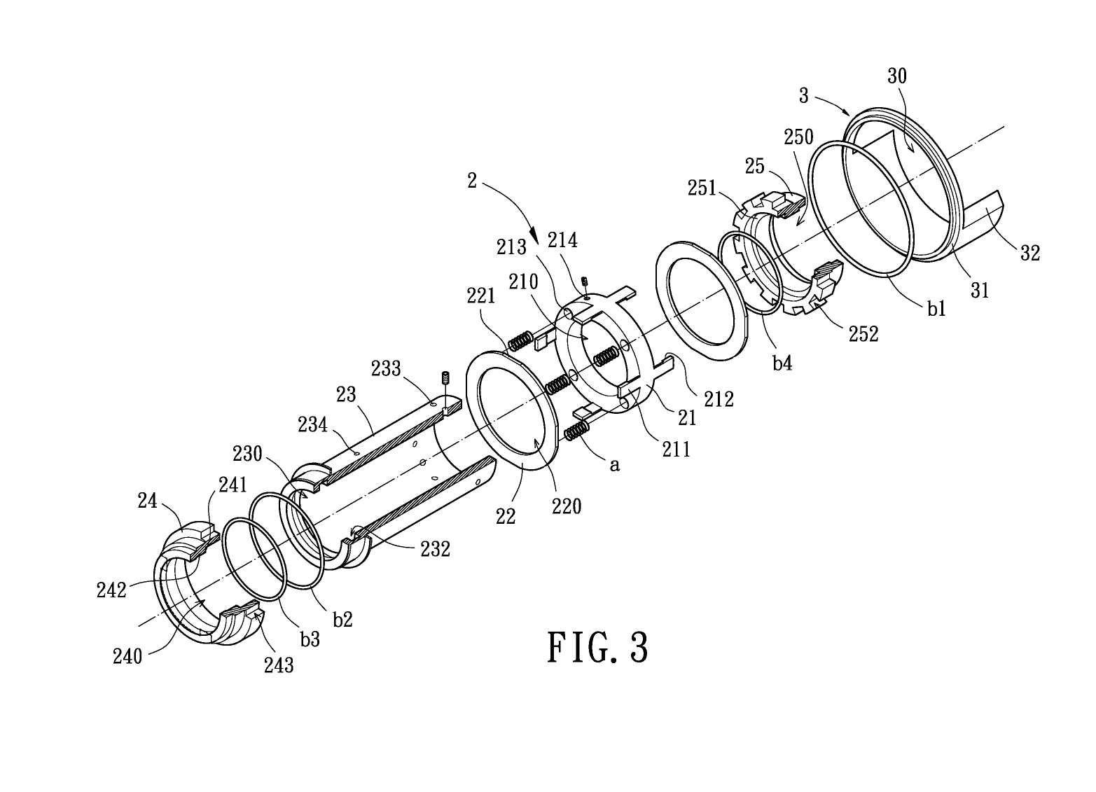

Still referring to FIG. 3, construction of the shaft-mounting seat 1 shall be described in detail. In this preferred embodiment, screw-connected with the shaft-mounting seat 1 is a shaft-seat cap 1′. The shaft-mounting seat 1 further includes a shaft bore 10, a coolant inlet 11, a coolant outlet 12 and a pair of fixed sealing rings 13. Preferably, the coolant inlet 11 and the coolant outlet 12 are formed on the shaft-seat cap 1′. The combination of the shaft-mounting seat 1 with the shaft-seat cap 1′ defines an inner wall to define the shaft bore 10 through which a rotary shaft 9 extends. A liquid dispenser apparatus (not shown) connects with the coolant inlet 11 and the coolant outlet 12 for coolant circulation in the interior of the shaft-mounting seat 1. In operation, the coolant functions to exchange heats generated between the shaft-mounting seat 1 and the shaft-supporting mechanism 2. In liquid circulation, the low-temperature coolant is injected into an interior of the shaft-sealing device through the coolant inlet 11 and then the high-temperature coolant is discharged from the coolant outlet 12. In rotational operation, heats due to abrasion of parts can be dissipated properly and thus an operational temperature of the shaft-sealing device can be lower. Preferably, one of the fixed sealing rings 13 is mounted in the shaft-mounting seat 1 while the other is mounted in the shaft-seat cap 1′.

The construction of the shaft-supporting mechanism 2 shall be described in detail, referring again to FIGS. 2 and 3. In the preferred embodiment, the shaft-supporting mechanism 2 includes a sealing-ring positioning assembly 21, a pair of pushing members 22, a sleeve body 23, a first rotatable sealing ring 24, a second rotatable sealing ring 25 and a plurality of sleeve-mounting members 26. Connected through the sealing-ring positioning assembly 21 are a series of spring holes to receive spring members identified as “a”. The pushing members 22 are located at either side of the sealing-ring positioning assembly 21 and are in contact with ends of the spring members “a” received in the spring holes. In assembling, each of the pushing members 22 is confronted with the corresponding rotatable sealing rings 24, 25 by spring forces of the spring members “a”. The sealing-ring positioning assembly 21, the pushing members 22, the first rotatable sealing ring 24 and the second rotatable sealing ring 25 are assembled on the sleeve body 23. The sleeve-mounting member 26 securely mounts the sleeve body 23 on the rotary shaft 9 by means of screw connections such that the shaft-supporting mechanism 2 may rotate with the rotary shaft 9.

Preferably, the rotatable sealing rings 24, 25 may be made of wear resisting alloy steel, carbon steel for example. The rotatable sealing rings 24, engage against the fixed sealing rings 13 mounted in the shaft-mounting seat 1 and the shaft-seat cap 1′, but they are still rotatable. Constructions of the sealing-ring positioning assembly 21, the pushing members 22, the sleeve body 23, the first rotatable sealing ring 24 and the second rotatable sealing ring 25 will be further described in greater detail below.

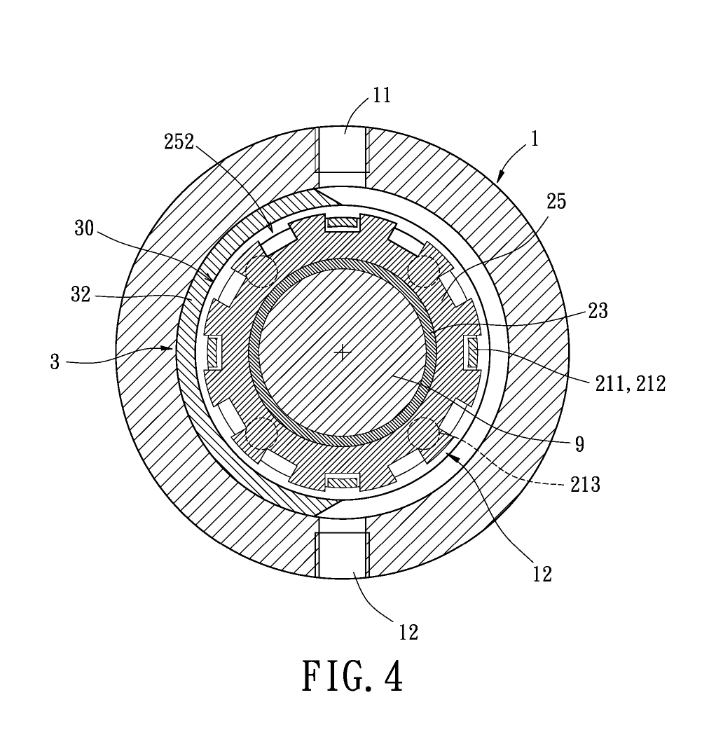

The construction of the liquid guiding member 3 shall be described in detail, still referring to FIGS. 2 through 4. In the preferred embodiment, the liquid guiding member 3 is provided with an axial hole 30, a stepped portion 31 and a pair of flow-guiding portions 32. A diameter of the axial hole 30 allows the passage of any section of the shaft-supporting mechanism 2 mounted on the rotary shaft 9, as best shown in FIG. 3. A resilient gasket (i.e. O-ring) identified as “b1” rests on the stepped portion 31 to seal a clearance existing between the inner wall of the shaft-mounting seat 1 and the liquid guiding member 3 such that any possible leakage of liquid is prevented. The flow-guiding portions 32 are located at a side opposite to that of the stepped portion 31. Preferably, the flow-guiding portions 32 are in alignment with the coolant inlet 11 and the coolant outlet 12 of the shaft-mounting seat 1, and have inclinations thereto, as best shown in FIG. 4. In circulation operation, the coolant supplied from the coolant inlet 11 or discharged to the coolant outlet 12 may run along the flow-guiding portions 32. More preferably, the flow-guiding portions 32 extend along a rotational direction of the rotary shaft 9.

Preferably, the sealing-ring positioning assembly 21 is a monolithic one-piece member provided with an axial hole 210, a plurality of engaging legs 211, a series of spring holes 213 and at least one screw hole 214. The axial hole 210 and the spring holes 213 connect between two opposite sides of the sealing-ring positioning assembly 21. In assembling, the axial hole 210 permits the sleeve body 23 to extend therethrough. Preferably, the engaging legs 211 are longitudinally extended in opposite directions to define limiting spaces (unlabeled) where the pushing members 22 are correspondingly restricted. Each of the engaging legs 211 has an engaging block 212 to limit any further longitudinal movement of the pushing member 22. In a preferred embodiment, the engaging block 212 is formed on an inner surface of the engaging leg 211. The spring holes 213 are equi-spaced on a periphery of the sealing-ring positioning assembly 21. Furthermore, the screw hole 214 is arranged on an outer circumference of the sealing-ring positioning assembly 21 such that the sealing-ring positioning assembly 21 mounts on the sleeve body 23 by means of a screw member.

Particularly referring to the FIG. 2, the pushing member 22 is formed with an axial hole 220 and a series of engaging cutaway portions 221 corresponding to the engaging legs 211 of the sealing-ring positioning assembly 21. In assembling, the axial hole 220 also permits the sleeve body 23 to extend therethrough. Preferably, the engaging cutaway portions 221 are equi-spaced on a periphery of the pushing member 22. Once the engaging cutaway portions 221 are engaged with the engaging legs 211 of the sealing-ring positioning assembly 21, any free rotational movement of the pushing member 22 with respect to the sealing-ring positioning assembly 21 is prevented.

Referring again to FIGS. 2 and 3, the sleeve body 23 is a monolithic body and includes a shaft-assembling hole 230, a positioning flange 231, an annular groove 232, a series of connection holes 233 and at least one screw hole 234. The shaft-assembling hole 230 longitudinally extends along the sleeve body 23 and permits the rotary shaft 9 to extend therethrough. The positioning flange 231 is disposed on an outer circumference of the sleeve body 23, and used to limit a resilient gasket identified as “b2” rested on the outer circumference of the sleeve body 23, as best shown in FIG. 3, so as to provide a greater sealing effect. In rotating operation, the resilient gasket “b2” functions to prevent any possible leakage of liquids contained in the liquid tank via a clearance existing between the sleeve body 23 and the first rotatable sealing ring 24. Provided on an inner circumference of the sleeve body 23 is the annular groove 232 in which to receive a resilient gasket identified as “b3”. Similarly, the resilient gasket “b3” functions to prevent any possible leakage of liquids contained in the liquid tank via a clearance existing between the sleeve body 23 and the rotary shaft 9. Preferably, the connection holes 233 are arranged on a distal end of the sleeve body 23 to receive screw members 26 which mount the sleeve body 23 on the rotary shaft 9 such that the shaft-supporting mechanism 2 and the rotary shaft 9 can be rotated together. More preferably, the screw hole 234 is arranged at a predetermined position of the outer circumference of the sleeve body 23 that is in alignment with a screw hole 214 of the sealing-ring positioning assembly 21. A positioning screw member (unlabeled) connects between the screw hole 214 and the screw hole 234 by means of screw connection.

Still referring to FIGS. 2 and 3, the first rotatable sealing ring 24 is provided with an axial hole 240, a first stepped portion 241, a second stepped portion 242 and a plurality of engaging notches 243. The axial hole 240 connects between two opposite sides of the first rotatable sealing ring 24. In assembling, the axial hole 240 also permits the sleeve body 23 to extend therethrough. The first stepped portion 241 and the second stepped portion 242 are formed on an inner circumference of the first rotatable sealing ring 24. Formed between the first stepped portion 241 and the positioning flange 231 is a space to receive the resilient gasket “b2”. During installation, the second stepped portion 242 can be used to engage with a distal end of the sleeve body 23 so that the shaft-supporting mechanism 2 can be stopped on a predetermined position of the rotary shaft 9. Formed on an outer circumference of the first rotatable sealing ring 24 are the engaging notches 243 which are equi-spaced on an annular flange (unlabeled). The number of the engaging notches 243 is corresponding to that of the engaging legs 211 extended from a first side of the sealing-ring positioning assembly 21, and the engaging legs 211 are engaged with the engaging notches 243.

Still referring to FIGS. 2 and 3, the second rotatable sealing ring 25 is provided with an axial hole 250, a stepped portion 251 and a plurality of engaging notches 252. The axial hole 250 connects between two opposite sides of the second rotatable sealing ring 25. In assembling, the axial hole 250 also permits the sleeve body 23 to extend therethrough. The stepped portion 251 is formed on an inner circumference of the second rotatable sealing ring 25. A resilient gasket identified as “b4” is received in the stepped portion 251. Formed on an outer circumference of the second rotatable sealing ring 25 are the engaging notches 252 which are equi-spaced on an annular flange (unlabeled). The number of the engaging notches 252 is equal to or more than that of the engaging legs 211 extended from a second side of the sealing-ring positioning assembly 21, and the engaging legs 211 are engaged with the engaging notches 252. In case of providing such additional notches 252, the second rotatable sealing ring 25 functions as an impeller to drive the coolant in the shaft-mounting seat 1 when the rotary shaft 9 is rotated.

Still referring to FIGS. 2 and 3, prior to assembling the shaft-supporting mechanism 2, one of the pushing member 22 is tilted and received in one of the limiting space delimited by the engaging legs 211 of the sealing-ring positioning assembly 21 at the first step. Once received, the engaging block 212 located each side of the sealing-ring positioning assembly 21 functions to limit a longitudinal movement of the pushing member 22 in the limiting space. This results in the pushing member 22 that can only reciprocate within a section defined between bottoms of the engaging leg 211 and the engaging block 212. Besides, each of the engaging legs 211 correspondingly engages with each of the engaging cutaway portions 221 of the pushing member 22 such that any unwanted rotation of the pushing member 22 can be prevented. All of the spring members “a” are correspondingly inserted into the spring holes 213 and confined by the pushing member 22. Subsequently, the other pushing member 22 is tilted and received in the other limiting space of the sealing-ring positioning assembly 21 in the same manner so that the spring members “a” are arranged between the pushing members 22. Accordingly, it is advantageous that the spring members “a” cannot be fallen off from the spring holes 213 of the sealing-ring positioning assembly 21 due to the pushing members 22 as well as obstructors.

A set of the sealing-ring positioning assembly 21 and the two pushing members 22 is assembled on the sleeve body 23 and then a screw member received in the screw holes 214, 234 of the sealing-ring positioning assembly 21 and the sleeve body 23, by referring again to FIG. 3. To confront with the fixed sealing ring 13, there is the first rotatable sealing ring 24 provided on a first distal end of the sealing-ring positioning assembly 21 adjacent to the liquid tank (unlabeled) and attached to the pushing member 22. To further confront with the other fixed sealing ring 13, there is the second rotatable sealing ring 25 provided on a second distal end of the sealing-ring positioning assembly 21 beyond the liquid tank (unlabeled) and attached to the other pushing member 22. Accordingly, the first rotatable sealing ring 24, the sealing-ring positioning assembly 21 and the second rotatable sealing ring 25 are completely mounted on the sleeve body 23 in order. Additionally, the engaging legs 211 of the sealing-ring positioning assembly 21 engage in the engaging notches 243, 252 of the rotatable sealing rings 24, 25 such that the rotatable sealing rings 24, 25 can be rotated with the sealing-ring positioning assembly 21 which is mounted on the sleeve body 23.

To guide a coolant flow in the shaft-mounting seat 1, the liquid guiding member 3 is provided. Preferably, each of the flow-guiding portions 32 has an inclination aligned with the coolant inlet 11 and the coolant outlet 12 respectively so that the coolant flow supplied from the coolant inlet 11 or discharged into the coolant outlet 12 can be guided, by referring to FIG. 4. Referring again to FIG. 3, the entire shaft-supporting mechanism 2 subsequently extends through the axial hole 30 of the liquid guiding member 3 while parts of the shaft-mounting seat 1 are assembled. In this circumstance, the rotatable sealing rings 24, 25 correspondingly engage against the fixed sealing rings 13 by means of the spring forces of the spring members “a” that bias the pushing members 22. Lastly, the shaft-supporting mechanism 2 is completely assembled and rotatably received in the interior of the assembled shaft-mounting seat 1 and shaft-seat cap 1′ as well as the shaft-sealing device. Preferably, an extension of the sleeve body 23 extends through the fixed sealing ring 13 and exposes to the outside of the shaft-seat cap 1′ via the shaft bore 10.

Referring again to FIG. 3, in use, the rotary shaft 9 extends through the shaft-assembling hole 230 of the sleeve body 23 so as to be supported in the assembled shaft-mounting seat 1 and shaft-seat cap 1′ if the shaft-mounting seat 1 and the shaft-seat cap 1′ are completely assembled. Once the rotary shaft 9 is received, the sleeve-mounting members 26 insert into the connection holes 233 of the sleeve body 23 so as to secure the extension of the sleeve body 23 on the rotary shaft 9. Consequently, the shaft-sealing device can be functioned.

In stirring operation, the rotary shaft 9 can rotate a stirring apparatus provided in the liquid tank for stirring the liquids contained therein. The sleeve body 23 fixed on the rotary shaft 9 causes the sealing-ring positioning assembly 21 and the pushing members 22 to rotation in the shaft-sealing device. Meanwhile, the sealing-ring positioning assembly 21 causes the rotatable sealing rings 24, 25 to synchronously rotation due to the engagement of the engaging legs 211 with the engaging notches 243, 252. In this circumstance, the rotatable sealing rings 24, 25 rotate with respect to the fixed sealing rings 13. To achieve a sealing effect, the first rotatable sealing ring 24 and the second rotatable sealing ring 25 correspondingly engage against the fixed sealing rings 13 by means of the spring members “a” so that liquids contained in the liquid tank cannot leak out between the fixed sealing rings 13 and the rotatable sealing rings 24, 25.

During rotations of the rotary shaft 9, there are abrasions occurring between the rotatable sealing ring 24, 25 and the fixed sealing rings 13, as best shown in FIG. 3. To eliminate any possible clearance, all of the spring members “a” continuously actuate the pushing members 22 to force the rotatable sealing ring 24, 25 for effectively engaging with the fixed sealing rings 13. Consequently, a perfect sealing effect between the rotatable sealing ring 24, 25 and the fixed sealing rings 13 can be automatically achieved even though they are operated over a long period of time.

Referring back to FIGS. 3 and 4, turbulences near the coolant inlet 11 may be minimized since the flow-guiding portion 32 of the liquid guiding member 3 can guide the coolant supplied from the coolant inlet 11 along a rotational direction of the rotary shaft 9, see the arrow shown in the upper portion of FIG. 4. Accordingly, it is advantageous that the coolant flow in the shaft-sealing device may be smooth. Similarly, turbulences near the coolant outlet 12 may be minimized since the other flow-guiding portion 32 of the liquid guiding member 3 can guide the coolant run to the coolant outlet 12 along a rotational direction of the rotary shaft 9, see the arrow shown in the lower portion of FIG. 4. Accordingly, it is advantageous that the coolant flow discharged from the shaft-sealing device may smoothly return to the liquid dispenser apparatus (not shown). Furthermore, a set of the untaken engaging notches 252 of the second rotatable sealing ring 25 can drive the coolant in the interior of the shaft-sealing device, as best shown in FIG. 4, for high-speed heat exchange. Accordingly, it is advantageous that the coolant flow of circulation can be speeded up.

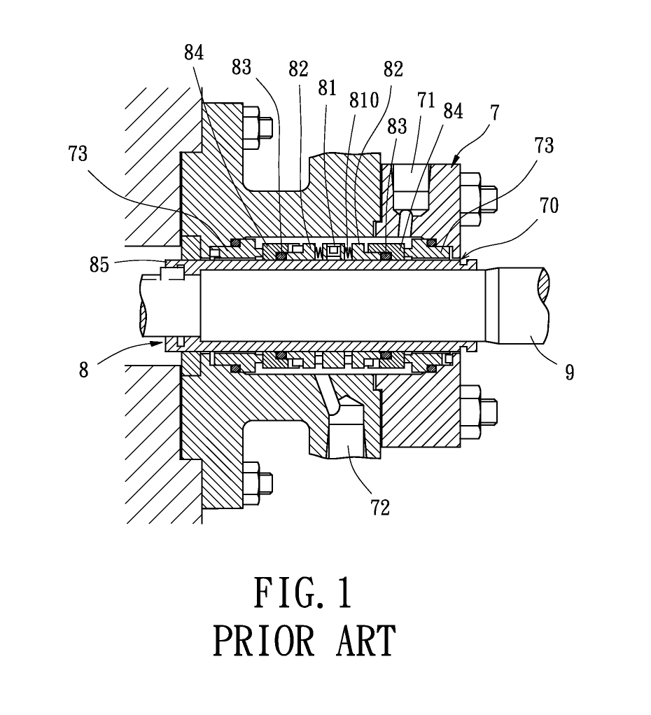

Returning to FIG. 1, in installing operation, the spring members 810 disposed between the sealing-ring positioning assembly 81 and the pushing members 82 may be unexpectedly disassembled. In other words, the conventional shaft-sealing device does not employ any means for positioning the spring members. As has been discussed above, the sealing-ring positioning assembly 21 in accordance with the present invention is provided with the engaging legs 211 and the engaging blocks 212 that restrict the movement of the pushing members 22 on the opposite sides of the sealing-ring positioning assembly 21. Consequently, it is advantageous that the spring members “a” cannot be fallen off from the spring holes 213 in installing operation due to the pushing members 22, as best shown in FIG. 3.

Additionally, the sleeve body 23 in accordance with the present invention is provided with the positioning flange 231 to position the resilient gasket “b2” that seals a clearance existing between the outer circumference of the sleeve body 23 and the inner circumference of the rotatable sealing ring 24. Conversely, the conventional shaft-sealing device is provided with the sleeve body 85 that does not employ any limiting means for positioning a resilient gasket, as shown in FIG. 1.

Lastly, the liquid guiding member 3 in accordance with the present invention is provided in the interior of the shaft-seat cap 1′ for guiding the coolant flow in the shat-sealing device. Conversely, the conventional shaft-sealing device is provided with no guiding means for minimizing turbulence of the coolant flow therein, as shown in FIG. 1.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A shaft-supporting mechanism for a shaft-sealing device, said shaft-supporting mechanism received in a shaft-mounting seat, comprising:
a sealing-ring positioning assembly including an axial hole, a plurality of first engaging legs, a plurality of second engaging legs and at least one spring hole, the first engaging legs extending from a first side while the second engaging legs extending from a second side opposite to the first side, at least one spring member being received in the spring hole;
a first pushing member disposed in a first limiting space defined by the first engaging legs of the sealing-ring positioning assembly, the first pushing member being in contact with the spring member;
a second pushing member disposed in a second limiting space defined by the second engaging legs of the sealing-ring positioning assembly, the second pushing member being in contact with the spring member;
a sleeve body provided with a shaft-assembling hole through which to extend a rotary shaft, the sleeve body extending through the axial hole of the sealing-ring positioning assembly and connecting therewith, the sleeve body is mounted on the rotary shaft;
a first rotatable sealing ring being abutted against the first pushing member on the sleeve body by the spring member; and
a second rotatable sealing ring being abutted against the second pushing member on the sleeve body by the spring member;
wherein the spring member actuates the first pushing member and the second pushing member so as to engage the first rotatable sealing ring against a first fixed sealing ring and to engage the second rotatable sealing ring against a second fixed sealing ring.

2. The shaft-supporting mechanism for the shaft-sealing device as defined in claim 1, wherein one of the first engaging leg and the second engaging leg is formed with an engaging block to limit one of the first pushing member and the second pushing member.

3. The shaft-supporting mechanism for the shaft-sealing device as defined in claim 1, wherein one of the pushing members is provided with at least one engaging cutaway portion to engage with one of the first engaging leg and the second engaging leg of the sealing-ring positioning assembly.

4. The shaft-supporting mechanism for the shaft-sealing device as defined in claim 1, wherein an outer circumference of the sleeve body is provided with a positioning flange to position a resilient gasket.

5. The shaft-supporting mechanism for the shaft-sealing device as defined in claim 1, wherein the first rotatable sealing ring is provided with a plurality of engaging notches to engage with the first engaging legs of the sealing-ring positioning assembly.

6. The shaft-supporting mechanism for the shaft-sealing device as defined in claim 5, wherein a number of the engaging notches corresponding to those of the first engaging legs.

7. The shaft-supporting mechanism for the shaft-sealing device as defined in claim 1, wherein the second rotatable sealing ring is provided with a plurality of engaging notchs to engage with the engaging leg of the sealing-ring positioning assembly.

8. The shaft-supporting mechanism for the shaft-sealing device as defined in claim 7, wherein the second rotatable sealing ring is provided with at least one untaken engaging notch to drive a coolant contained the shaft-sealing device.

9. The shaft-supporting mechanism for the shaft-sealing device as defined in claim 1, wherein the shaft-mounting seat includes a coolant inlet and a coolant outlet.

10. The shaft-supporting mechanism for the shaft-sealing device as defined in claim 9, further comprising a liquid guiding member in alignment with the coolant inlet and the coolant outlet.

11. The shaft-supporting mechanism for the shaft-sealing device as defined in claim 10, wherein the liquid guiding member includes at least one flow-guiding portion.

12. The shaft-supporting mechanism for the shaft-sealing device as defined in claim 11, wherein the flow-guiding portion has an inclination to one of the coolant inlet and the coolant outlet.

13. The shaft-supporting mechanism for the shaft-sealing device as defined in claim 11, wherein the flow-guiding portion extends along a rotational direction of the rotary shaft.

14. The shaft-supporting mechanism for the shaft-sealing device as defined in claim 2, wherein the engaging block is formed on an inner surface of one of the first engaging leg and the second engaging leg.

15. The shaft-supporting mechanism for the shaft-sealing device as defined in claim 4, wherein an inner circumference of the first rotatable sealing ring is provided with a first stepped portion corresponding to the positioning flange of the sleeve body.
